(19) United States
(12) Patent Application Publication
(10) Pub. No.: US 2002/0020048 A1
(43) Pub. Date: Feb. 21, 2002

(54) Method and machine for the manufacture of metallic frames for inner spring mattresses

(76) Inventor: P.A. Anagnostopoulos, Anthens (GR)

Correspondence Address: BELL, BOYD & LLOYD LLC, P.O. Box 1135, Chicago, IL, 60690-1135, US

(21) Appl. No.: 09/739,779

(22) Filed: Dec. 18, 2000

(30) Foreign Application Priority Data
Apr. 22, 1999 (GR) 990100137
Apr. 24, 2000 (GR) PCT/GR00/00019

(51) Int. Cl. B23Q 17/00; G01M 19/00

(52) U.S. Cl. 29/407.01; 29/33 R

(57) ABSTRACT

A method and machine for the production of metallic frames for innerspring mattresses with the simultaneous clipping of the two free ends are revealed. The method is characterized by the principle that the one free end is secured in a gripper, which is sliding on an arm and thus can follow the straight development of the wire as well as the bends of the frames. On completion of the last side and angle the free end of the frame is guided from the gripper and the arm in the clipping mechanism where automatically all the clipping phases are taking place.

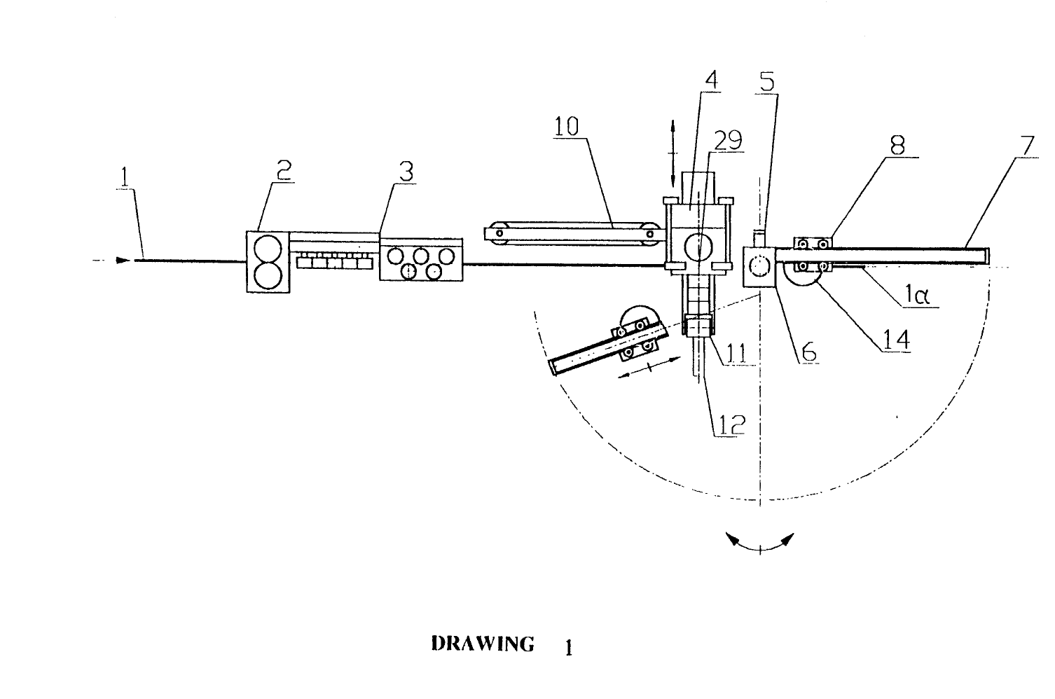

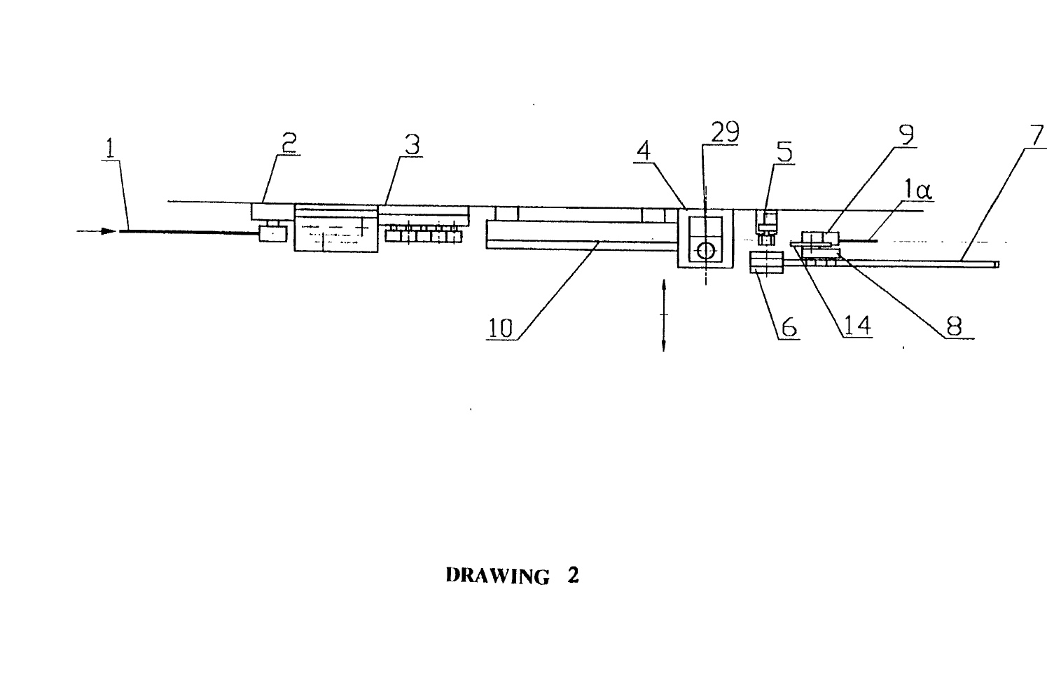

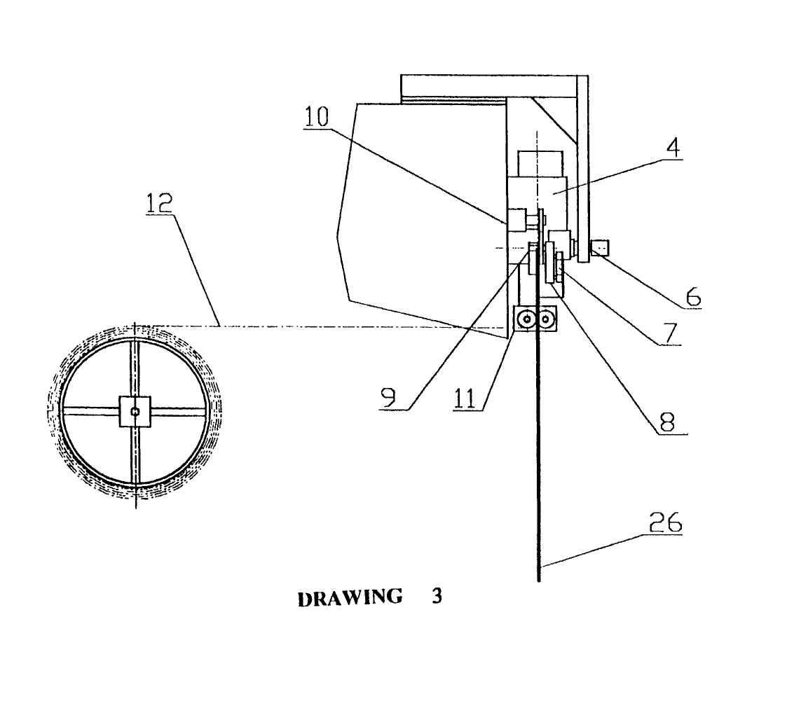

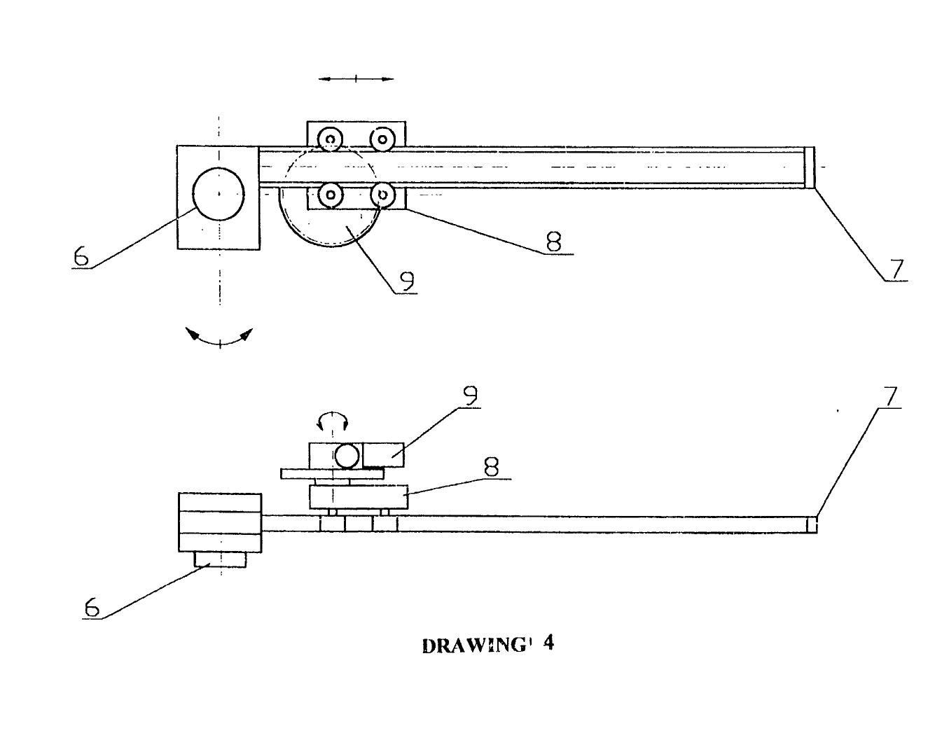

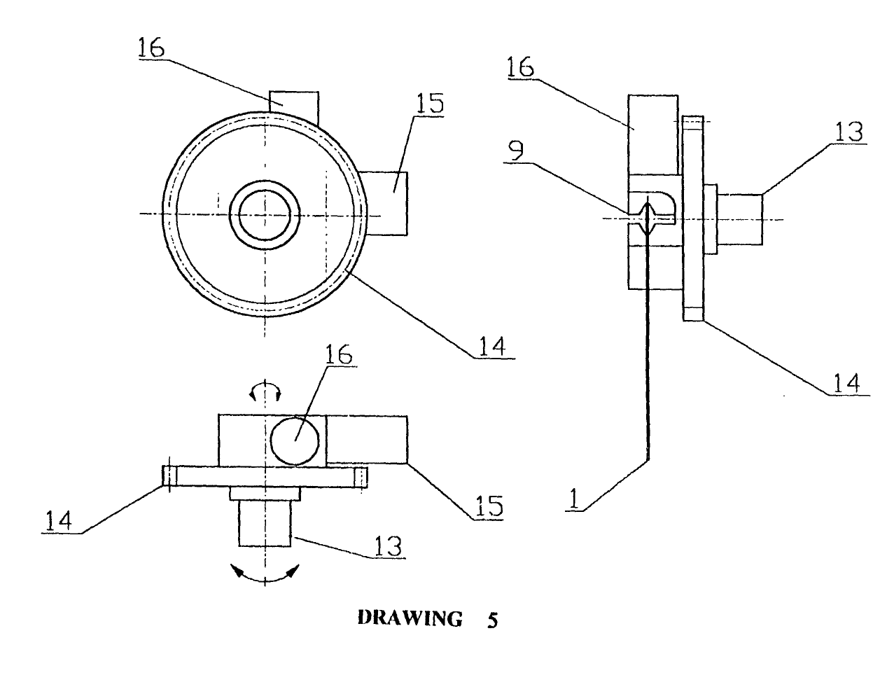

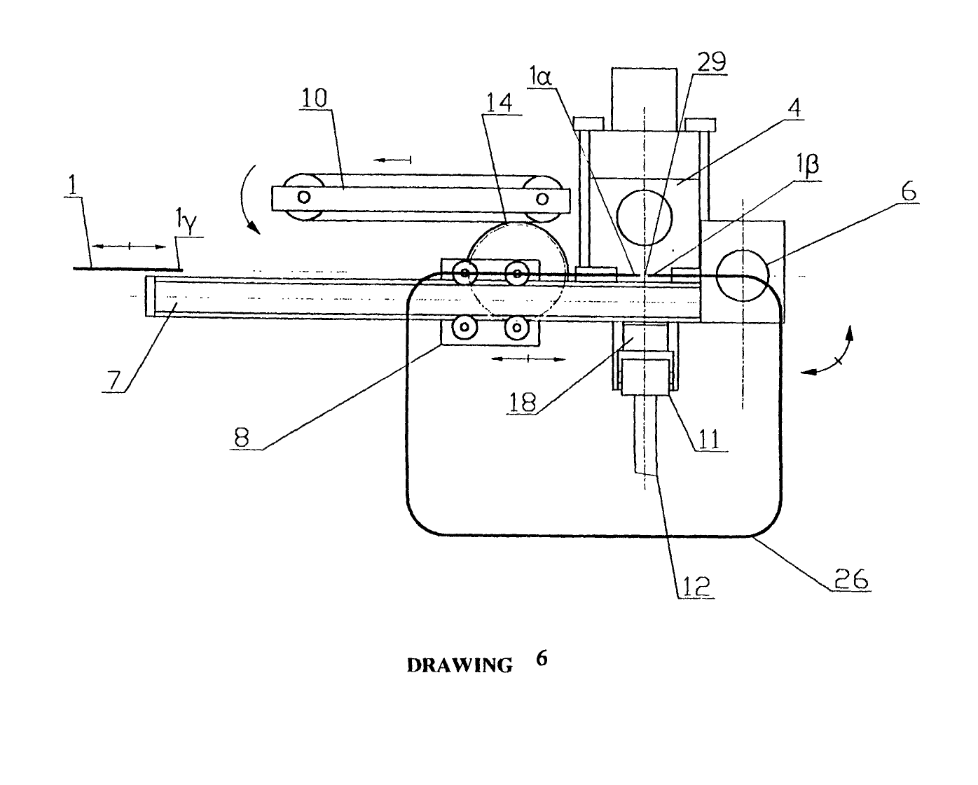

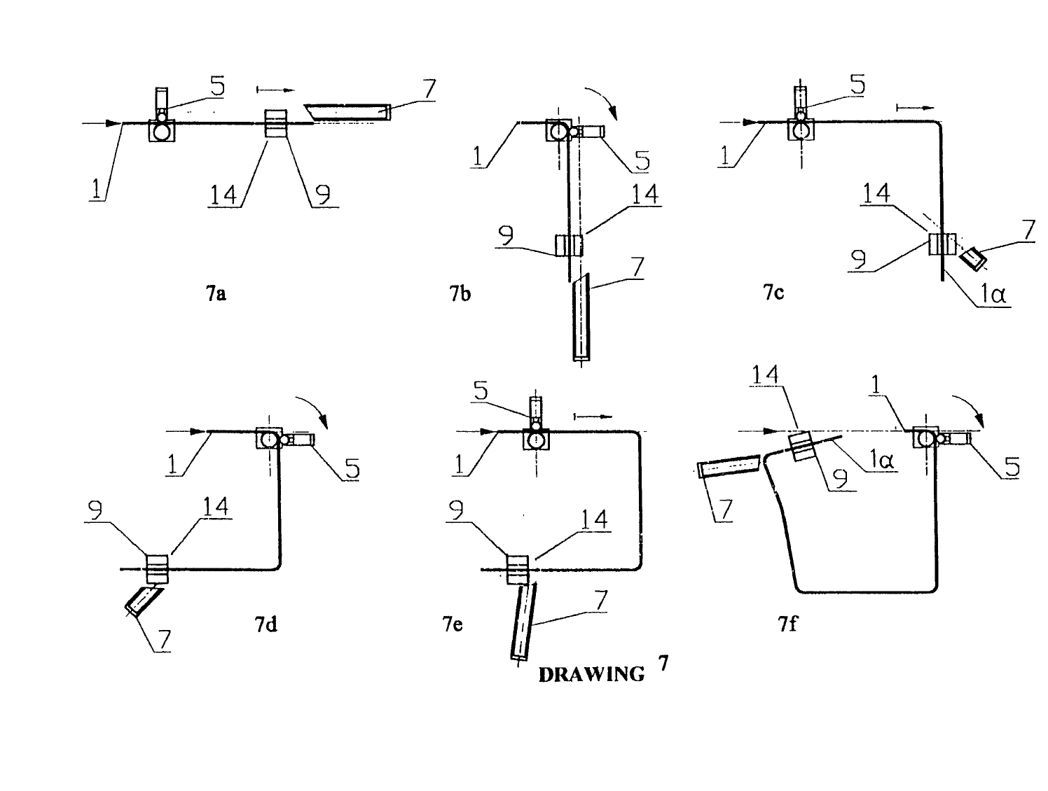

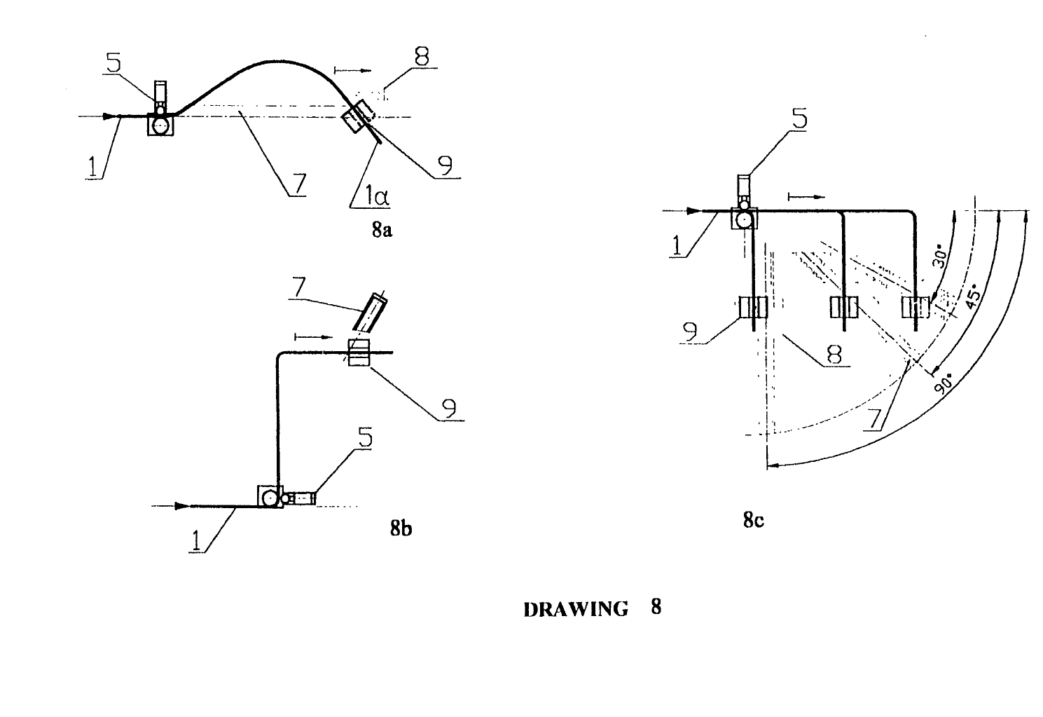

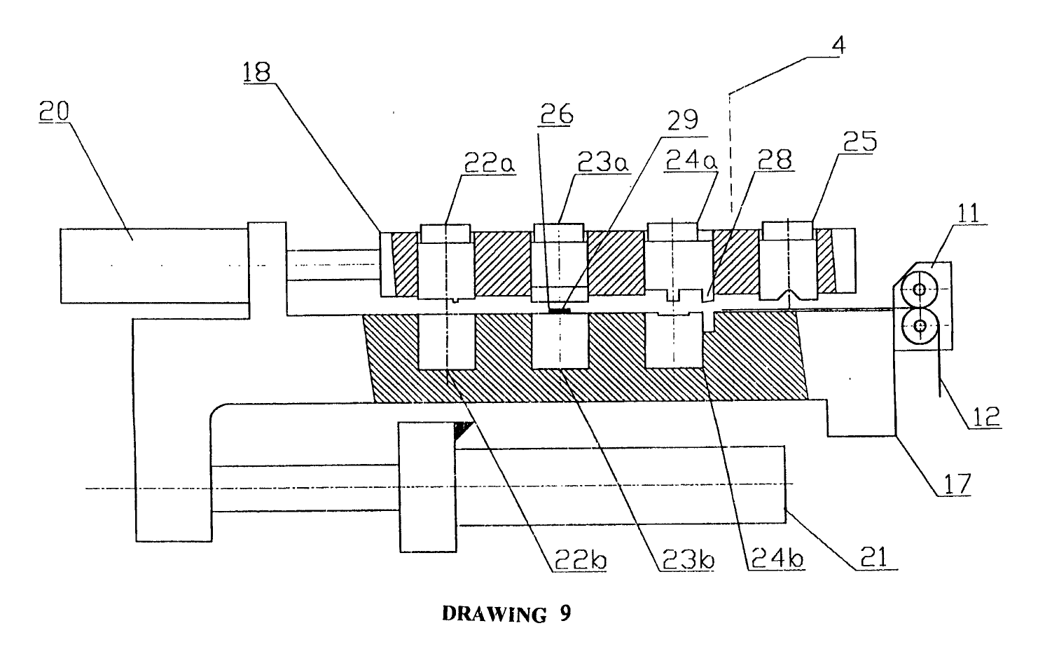

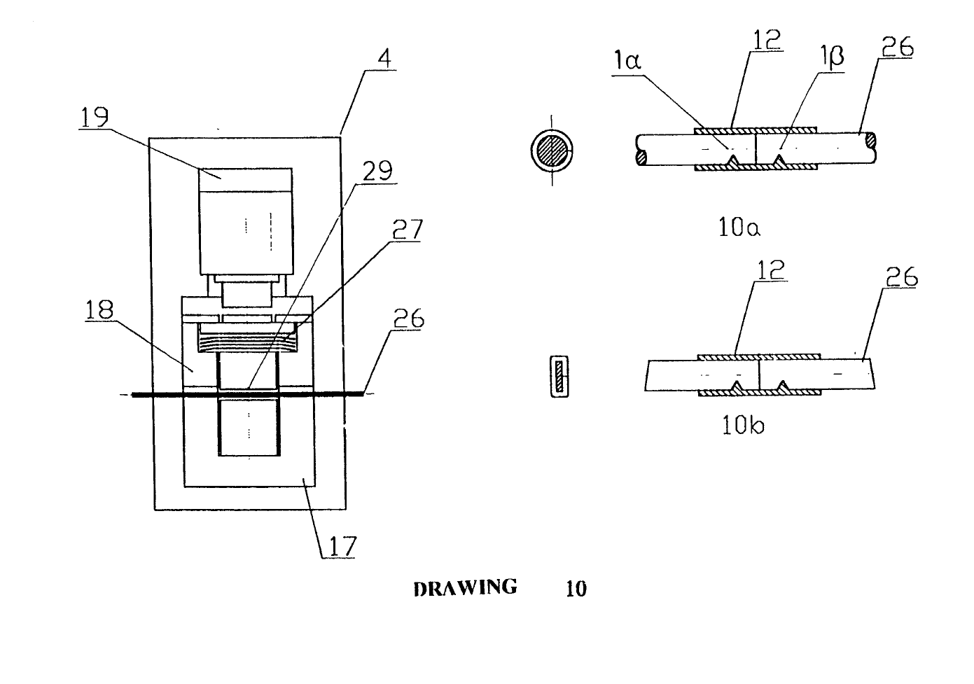

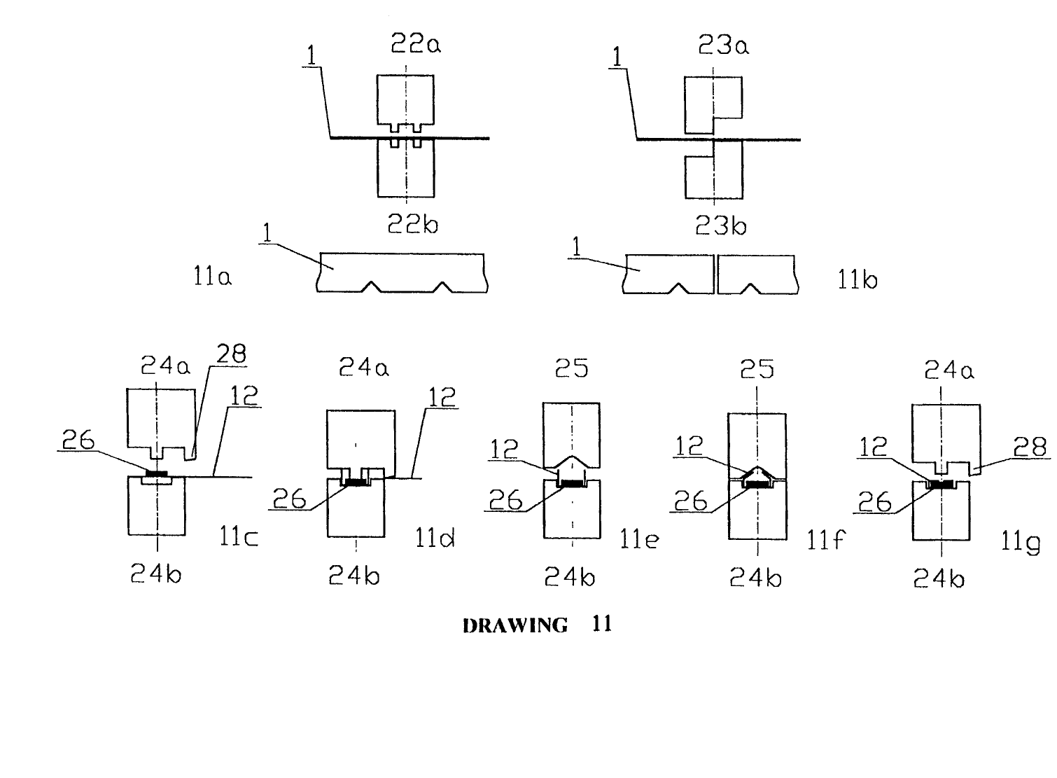

It is known that metallic frames, which are made of round wire or flat round wire and the ends of which are connected rigidly together with a plate, are necessary for the manufacture of inner spring mattresses for the circumferential support of the springs. The said closed frames have the shape of the mattress under construction.

The most widely used method of construction of such metallic frames necessitates the use of at least two machines, the design of which is based on a method for the formation of round wire or flat wire, the stages of which follows the following series: feeding and straightening of the round wire or of the flat wire, bending into the final shape of the frame, cut-off, collection and transportation of the open frame manually to a connective machine and finally, connection of the two ends with a metallic clip.

Alternatively, the connection of the two ends is performed with a small tube instead of the plate or with butt-welding.

The principal drawbacks of the existing technology are two machines are used: the straightening-bending machine and the connective machine, which are independent of each other. For this reason, manual work is necessary for the collection and transportation of the open frame to the connective machine. The worker collects the difficult to handle open frame, which bends easily, transports it to the connective machine, supplies the machine with the said open frame suitably positioned, activates the machine, which connects the two free ends of the open frame with a metallic clip or a small tube or by butt welding in the sequel the worker collects the closed frame and repeats the above procedure for each new frame for construction. It must be emphasized that the manual actions are usually performed by more than one worker for achieving a decent productivity.

During bending all the sides of the already manufactured frame rotate with respect to one of its corners. As the frame is still open during the bending process, it exhibits a high degree of flexibility. For this reason the speed of rotation of the frame and consequently the speed of the bending is low. The movement of the open frame requires a large space and leads to an horizontal arrangement of machine of large sizes, e.g. for rotating a frame cross section of 2 meters×2 meters with respect to one of its corners, a free circular space of a radius equal to its diagonal is required, e.g. of 2,8 meters. The bending step in an horizontal arrangement after the two ends of frame under construction is free leads to low speeds of feeding of the round wire or flat wire.

Due to the flexibility and due to the fact that the two ends of the frame are free, the handling performance is especially difficult, both during the collection and during suitable positioning of the two ends in the connective machine. This is the principal reason that until today, the complete automation of the production of open frames for inner spring mattresses has not been possible and for the necessity for manual work by the personnel.

There is another method through which the round or flat wire is getting straightened at first, then is fed and measured simultaneously, the total length all the frames' sides.

Then on the same machine the wire is cut and automatically the two wire free ends are joined together with a metallic plate. This closed shape is then processed on a bending station, which starts to measure the length of each side, and then bends them. This is taking place for all the sides and the angles of each frame.

With the above method the use of two machines is avoided but there is the need of two measuring systems which necessitates the use of two motors with a resulted delay on the production process because the length is measured twice. So the machine becomes more complicated and expensive.

The purpose of the present invention is to overcome the above described problems by offering a method allowing the fill automation on the production of the metallic frames for the innerspring mattresses.

The new method is offering a new capability for the production of clipped frames by achieving the measuring and the bending of the sides on a single station thus avoiding the need of a second measurement.

This is achieved because with the use of a gripper (9) (Drawing 2 and Drawing 5) which slides on a special slide arm (7) (Drawing 1), the free end of the round flat wire is secured and it can free follow the wire advances and bends of the frame sides up to the point where the whole/total length has been completed. Then the cutting action is applied and the gripper by making a complete 360° degree turn through the Slide Arm comes and applies the wire free end on to the other wore free end then the final clipping process by the use of a metallic plate or butt weld (Drawing 10) (10a, 10b) is applied.

### ADVANTAGES OF THE INVENTION

The advantage is that all the necessary operations for the manufacturing of the frame are taking place in one continuous phase.

Thus the productivity is increased and the production cost of the machine is decreased because the double wire driving systems as well as the electronic measurement are avoided through two servo Motors.

### DESCRIPTION OF DRAWINGS

Drawing 1 is a side view and a part section of the machine for the production of metal frames for Innerspring Mattresses.

Drawing 2 is a top view and a part section of the machine.

Drawing 3 is a complete section view of the machine.

Drawing 4 is a side view and a top view of the Arm with the slide and the gripper.

Drawing 5 is a section view, a side view and a top view of the gripper.

Drawing 6 is a side view of a frame prior to its clipping.

Drawing 7 is illustrating the successive phases for the production of a metallic frame.

Drawing 8 illustrates the bending of the wire after the completion of the gripper's travel, one left bend and successive positions of the Arm and the gripper after the first bend.

Drawing 9 illustrates a side view of the central carrier mechanism for the wire free end connection.

Drawing 10 illustrates a section view of the central carrier mechanism for the wire free end connection.

Drawing 11 illustrates the successive phases of the clipping tool pairs for the wire free end connection of the metallic fame.

### DESCRIPTION OF THE METHOD AND THE MACHINE

More details for the present invention will be made understood from the detailed application description that is described below with cross-reference the drawings.

The described method aims to secure in a gripper the wire free end of the created frame made of round wire or flat wire and to hold it there until all the sides and the corners have been completed and then to turn it through a 360° degrees on the side level to the frame and to guide it so to touch the other free end of the frame thus the connection phase of the two free ends to follow.

So all the production phases are taking place on one single mechanism.

With this method, the holding of the frame's free end by the use of a gripper does not prevent the creation of the sides and the corners of the metallic frame but most important not torsion of the sides or distortion of the corners is taking place because it freely follows the successive changes of the length and the corners. The present invention creates all the conditions in order to overcome the solution of the problem.

This is achieved as follows:

One gripper (9) (Drawing 2, 3, 4) which is waiting immediately after the bending mechanism (5) (Drawing 1, 2, 3) secures the free wire end (1a) (Drawing 1, 5) with the use of the jaws, which are activated by the use of a piston force (16) (Drawing 5).

The gripper is got the capability to perform 3 different actions. Its first action is that it is capable to rotate ±180° through its axis (13) (Drawing 5) so obtaining different positions (Drawing 7, 8) guided freely from the respective inherent forces of the wire arising from the successive production phases of the metallic frame through its rotation to the perpendicular and parallel level towards the wire central line movement.

The action of the gripper is taking place through its slide movement on the Arm (7) (Drawing 1, 2, 3, 4) on the special slide (8) (Drawing 1, 2, 3, 4) where it is secured as well through its axis of rotation (13) (Drawing 5). The original position of the arm is parallel to the wire direction (Drawing 1).

The third action is taking place through the above-mentioned arm, which is capable to rotate ±180° around its axis (6) (Drawing 1, 2, 7) to a level perpendicular and parallel to the wie direction. So the gripper with the free wire end secured in it (1a) can follow the created wire forces during its advance by its rotation and slide capability around its axis (13) (Drawing 5) in addition to the fact that it follows the created forces of the wire during the bend formation because itself gets bend the same way.

All the above movements are necessary in order the wire of the Metallic Frame not to sustain permanent deformation. This would have occurred if the gripper could not perform free movements.

The Arm's length is determined from the elasticity limit of each wire according to its diameter and tensile strength.

In this predetermined length the respective wire can create an elastic loop until the side length has been completed.

In Drawing 7 the 6 phases of the wire advance and bend are showing.

In Drawing (7a) the gripper is sliding by the exerted force from the round or flat wire (1). In drawing (7b) the bending mechanism (5) bends the wire and the arm (7) takes the same angle through rotation from the external movement. In Drawing (7c) is illustrated that the wire is advanced and the Arm took an inclined position while the gripper kept its distance from the wire Axis.

In Drawing (8c) (Drawing 8) it is showed the successive arm's and gripper's position of the arm and the gripper's during the wire advance. On positions (7a, 7e, 7b) (Drawing 7) are illustrated the successive positions of the Arm and the gripper. In Drawing (8a) is illustrated the curve of the wire when the gripper (9) terminates its slide on the Arm (7) and the wire advance is carrying on to supply more wire length. With the capability which is given to the wire to create a loop the distortion of its free end is avoided (1a) (Drawing 8) then the gripper is following through its rotation thus the permanent viire distortion is avoided.

On Drawing (8b) (Drawing 8) the position of the Arm is showed immediately after a left bend. The Arm is rotated each time at the same angle degrees the wire is getting bended. However, after each bend is being let free in order to follow the forces created by the mere and its advances.

After each wire advance for the creation of a new frame side the equilibrium position is not disturbed from the followed bend because the created angle between the wire direction and the Arm's direction is kept constant during the bend.

When all the sides and the angles of the required frame have been completed the Arm (7) is pushed to rotate and finish to the ±180° (Drawing 6) position irrespective of its position at the time.

The gripper carries a sprocket (14) (Drawing 2, 5, 6) on its rotation axis.

At the above mentioned position where the Arm terminates, the sprocket is engaging with the chain of the system (10) (Drawing 6).

By this engagement the rotation of the gripper is achieved in order to complete +180° turn around its axis (Drawing 6).

By the +180° rotation that the arm and the gripper have achieved a total of +360° degrees are completed from the initial position and the gripper is standing once more horizontally holding the wire parallel and at the same height with the central line of the wire. Also, from the movement of the system (10) (Drawing 6) the carrier (8) (Drawing 6) is forced to more right ways until the wire free end (1a), which comes out of the gripper (1a) (Drawing 6) to touch the other free end of the frame (1b) which is located at the center of the clipping press (29) (Drawing 6) which coincides with the wire's central line.

This is achieved as follows:

When the last side end corner of the metallic frame is completed then the wire (1) is cut at the point (29) (Drawing 1, 2, 6) and the second free end of the frame (1b) (Drawing 6) is secured at this position—with a system that is not described here—thus awaiting the free end (1a) in order the clipping operation of the two ends to follow.

The free end of the next frame (1c) (Drawing 6) is retarded so to allow the necessary space free for the frame free end (1a) (Drawing 6) (Drawing 9) to come in order the two free ends of the same frame (1a, 1b) to get joined together via the mechanism (17, 18) (Drawing 9, 10). The free wire end (1a) is forced to bend slightly in order to move side ways and to be at the same straight line with the wire central line (1) and the free end (1c).

The clipping mechanism of the frame free ends (17, 18) (Drawing 9, 10) is consisting of two parts, the central carrier (17) (Drawing 9) and the inside to the carrier sliding part (18) (drawing 9). The central carrier together with the part (18) is capable to slide within the clipping press (4) (Drawing 1, 2, 6, 9, 10) under a perpendicular to the wire and to the press axis piston (19) (Drawing 10) movement.

The central carrier contains two rows of tools parallel towards the body of the carrier (17) and amongst themselves.

One row is got 3 tools (22b, 23b, 24b) (Drawing 9) which are screwed on the main body of the central carrier like drawing 9) indicates.

The second row which is located on the moving part (18) contains 4 tools (22a, 23a, 24a, 25) (Drawing 9) and is located across the first row.

The wire (Round or Flat) is coming in between these two rows of tools (26) (Drawing 9, 10). The tools in stages by the carrier movement and two at a time are pressing through point (29) Drawing 10) where behind the moving row the piston (19) is located.

The central carrier (17) can obtain 3 different positions in order to put each of the 3 tools at the center (29) of the clipping press (4) Drawing 10).

The part (8) moves inside the central carrier and is got two additional positions relative to the central carrier (17).

So 5 different pairs of working tools are created.

Pair (22a-22b) (11a) (Drawing 11).

Pair (23a-23b) (11b) (Drawing 11).

Pair (24a-24b) (11c) (Drawing 11).

Then by changing position of the moving part towards the left without altering the central carrier (17) a new pair (25-24b) (11c) (Drawing 11) is created.

Finally, by returning the moving part to its original position and then move it towards the right this time a new pair is created (24a-24b) (11g) (Drawing 11).

At the center (29) of the press (4) (Drawing 9, 10) the piston (19) is existing which is activated every time a pair of the above described pressing pair tools is formed.

The 4 tools of the moving part are capable to slide thus by pressing them through the piston (9) to move towards the other tool across which constitutes the pair.

Then are returned back to their oral position through the return Spring Action (27) Drawing 10).

The sequence of the tool pair operations is:

1. The first pair (22a-23b) (Drawing 11) creates a dent on the Round wire or Flat wire which is absolutely necessary to achieve strong clipping of the frame wire ends.

2. The second pair (23a-23b) (Drawing 11) cuts the wire.

3. The third pair (24a-24b) achieves 2 functions which are described on phase (11c and 11d) (Drawing 11).

During this function the metal plate (12) (Drawing 1, 3, 6, 9, 10, 11) by which the clipping of the two wire ends is achieved (1a, 1b) (Drawing 10) is advanced from the mechanism (11) (Drawing 1, 6, 9) so to reach the tool pair (24a-24b) which is illustrated at phase (11c) (Drawing 11) and underweight the two frame wire ends (26( (Drawing 9).

When the piston presses the tool (24a) towards the tool (24b) (11c) Drawing 11) the dipping material is cut (28) (Drawing 11) and then is deformed as described on (11d) and (Drawing 11).

4. The fourth pair (25-24b) (Drawing 1) deforms the clipping material as described on (11f) (Drawing 11).

5. The fifth pair is created by the return of the moving part (18) towards the right thus we have got the pair as phase three (24a-24b) as illustrated at (11g) (Drawing 11).

In this phase the piston action achieves a different result, because there isn't any clipping material to be cut and the tool presses the two frame ends thus achieving the final result (10a, 10b) (Drawing 10).

After this phase the clipped frame is removed through gravity or mechanic mechanism.

1. Method for the production of metallic frames, for innerspring Mattresses, clipped through their free ends (10a, 10b) (Drawing 10).The metallic frames are made of round wire of any diameter or flat wire of any cross sectional area capable to sustain plastic deformation. The method is consisting of the straightening phase (3) (Drawing 1), the electronic measurement (2) (Drawing 1) of the wire length of the sides, the angle bending (8b) (Drawing 8) anticlockwise or (7b) (Drawing 7) clockwise, the denting creation at the surface of the material (11a) (Drawing 11) and specifically at the free ends cut off points (11b) (Drawing 1) and finally the free ends joiling through the use of a metallic plate (26) (Drawing 11) or welding. A quantity of the initial wire length (1a) (Drawing 2) is secured in a gripper (9) (Drawings 2, 5) which through a special carrier (8) Drawing 1) is sliding on a special designed arm (7) (Drawing 2) which is awaiting in a parallel position with the wire central line (1) (Drawing 1) and at the same time is capable to rotate around one of its side on the same horizontal axis (6) (Drawing 4). Around this horizontal axis the bending is taking place at a level perpendicular and parallel with the level of the central line of the wire throughout ±180° degrees. The gripper is following the wire action through a sliding action in conjunction with the arm, which is following each wire bend. The gripper is capable to rotate around an axis (13) (Drawing 5) which is connecting it with the carrier. It is moving on a plane perpendicular and parallel to the wire central line by taking a position according to the created wire stresses (8C) (Drawing 8) in order to avoid wire deformation during the successive advances and bends. The secured frame's free end is guided through a ±360° rotation action to its original position at the appropriate position (Drawing 6) in order to meet the second free end of the metallic frame which is in turn secured after its cut. Then the joining is taking place through a metallic plate in five different phases (Drawing 11) through an appropriate mechanism.

2. Method of manufacturing metallic frames for innerspring Mattresses according to claim 1 which is consisting from the principle that the free end of the required frame (1a) (Drawing 1) is secured in a gripper (9) (Drawings 1, 2, 5) and gets free only when all the frame sides and comers have been completed and the joining has taken place through a metallic plate or a welding.

3. Method of manufacturing metallic frames for Innerspring Mattresses according to claim 1 which is consisting from the principle that two bending axes are used (5, 6) (Drawing 1), one wire (1) (Drawing 1) and a gripper arm system (7) (Drawing 1) which holds and guides the beginning (free end) of the frame. All the systems are operated simultaneously in order during the bending, the beginning and the respective end of the semifinished frame are kept at a constant angle relationship between them. The arm is assisting by carrying part of wire length in order permanent wire deformation to be avoided thus increasing the bending speed as well.

4. Method for the production of metallic frames for innerspring mattresses according to claim 1 which is consisting from the principle that the gripper is capable to rotate ±180° degrees around an axis (13) (Drawing 5) perpendicular to the wire central line.

5. Method for the production of metallic frames for innerspring mattresses according to claim 1 which is consisting from the principle that an Arm is used with a length depending upon the elasticity limit of the frame's wire in order after the termination of the gripper's travelling distance and assuming that the side of the required frame requires larger amount of wire length allows the wire to create a loop in a perpendicular and side level (8a) (Drawing 8) with the appropriate amount of wire length in order to avoid permanent wire plastic deformation.

6. Method for the production of metallic frames for innerspring mattresses according to claim 1 which is consisting from the principle that after the first bend and the consequent wire advance the arm through a rotation around its axis is capable to move following with its free end the direction of the wire advance in conjunction with the gripper which through the sliding carrier also achieves suitable positions (8c) (Drawing 8) in conjunction with the necessary rotational action in order all the appropriate conditions to be created for the semi-finished frame in order permanent deformation to be avoided.

7. Method for the production of metallic frames according to claim 6 which is consisting from the principle that during the wire advance after the first bend the combination of the three required movements i.e. the arm's rotation (7), the carrier's (8) sliding across the length of the arm, and the gripper's rotation (6) around its axis are controlled by Industrial Electronic Computer in order to optimize their positions and thus avoiding the permanent plastic deformation of the wire.

8. Method for the production of metallic frames according to claims 1, 2, 3, 4, 5, 6 and 7 which is consisting from the principle that the produced metallic frame contains anticlockwise bends (8b) (Drawing 8) as well as clockwise bends (Drawing 7) and the movements of the arm of the carrier and the gripper's rotation are operating in the same sort of way for the anticlockwise bends.

9. Method for the production of metallic frames according to claim 1 which is consisting from the principle that when all the sides end the corners of the required metallic frames have been completed then the arm with the gripper rotates up to the ±180° and arrives in parallel position with the wire central line and then the gripper is forced to rotate up to the ±180° in order the secured frame's free end to rotate in total ±180°+180°=+360° (Drawing 6). From this position the carrier (8) is attracted with the gripper towards the press (4) (Drawing 6). Then, the gripper's center (19) (Drawing 6) with the frame's free end is guided and inserted in the clipping mechanism (17, 18) (Drawing 9) where after the clipping operation of the two free ends has taken place the gripper opens and the ready metallic frame is dropping and is being taken place with a special mechanism. Then the arm rotates −180° and takes its zero position while the gripper rotates −180° as well around its axis and remains open in order to accept the next free frame end.

10. Mechanism for the production of metallic frames for innerspring mattresses made of round or flat wire with an attached automatic clipping process of the two free ends with the use of a metallic plate (12) (Drawing 10) after the creation of dents at the two frames free ends and the wire cutting process at the required length. The clipping process is characterized of five different phases (11a, 11b, 11d, 11f, 11g) (Drawing 11) and is taking place in a press (4) (Drawing 1) through a mechanism which contains a carrier (17) (Drawing 9) which is sliding inside the press body perpendicular to the wire axis. It also contains two parts (17, 18) which are carrying the clipping tools thus creating working pairs of five different combinations (Drawing 11) in order for the clipping process to be effectively applied.

11. Mechanism for the production of metallic frames for innerspring mattresses made of round or flat wire according to claim 10 which is characterized from the principle that the free end clipping is achieved through a central carrier (17) (Drawing 9, 10) which is sliding within the press (4) (Drawing 9, 10) body on a slide perpendicular to the wire central line and contains two parts located across to each other. The wire is processed within the two parts. The one part is located on the body of a carrier (17) containing three clipping tools fixed on it. The other part (18) contains four clipping tools, which are doing three movements.
The first is the move they are doing alongside the central carrier. The second is the independent move of each tool when each tool is being in front of the press (19) (Drawing 10) and is forced to move across to meet the other clipping tool thus carrying a part of the clipping process and the third is common for the four tools of this part which is having its own movement by sliding with in the central carrier lengthwise so creating the fourth (11e) (Drawing 11) and fifth (11g) (Drawing 11) clipping phase.
During the first phase (11a) (Drawing 11) the first clipping tool of each part creates a pair which is creating dents on the wire. The second pair (11b) (Drawing 11) is cutting the wire. The third pair is cutting the clipping material for the frame's free end joining in conjunction to perform a first deformation of the clipping material. The fourth pair performs the location of the clipping material around the wire. The fifth pair achieves the final pressing (11g) of the clipping material around the frames' free ends.

12. Mechanism for the production of metallic frames for innerspring mattresses according to claims 10 and 11 which is characterized that the clipping material (12) (Drawing 9) for the connection of the two free ends is driven at the third clipping phase (11c) (Drawing 11) from a set of metallic counting rollers (11) (Drawing 9) which are giving the exact required material length and are secured on the external side of the central carrier (17) (Drawing 9).
